(19) United States
(12) Patent Application Publication
(10) Pub. No.: US 2021/0074090 A1
(43) Pub. Date: Mar. 11, 2021

(54) SYSTEM AND METHOD FOR SIMULTANEOUS PERFORMANCE LAUNCH OF MULTIPLE VEHICLES

(71) Applicant: GM Global Technology Operations LLC, Detroit, MI (US)

(72) Inventors: Timothy David Neumann, JR., West Bloomfield, MI (US); Devon R. Hall, Ann Arbor, MI (US); Anthony J. Sumcad, Troy, MI (US)

(21) Appl. No.: 16/564,384

(22) Filed: Sep. 9, 2019

(51) Int. Cl. G07C 5/08; G07C 5/00; B60W 30/18; H04W 4/46; H04W 4/44

(52) U.S. Cl. CPC G07C 5/0816; G07C 5/008; B60W 2550/408; H04W 4/46; H04W 4/44; B60W 30/18

(57) ABSTRACT

A multiple vehicle launch system for an automobile vehicle includes a vehicle-to-infrastructure (V2I) communication system to track performance data of a vehicle launch event of a first and a second automobile vehicle and coordinate getting the first and second automobile vehicles to a driving area to conduct the vehicle launch event. A vehicle-to-vehicle (V2V) communication system provides direct communication between the first and second automobile vehicles at the driving area to coordinate a simultaneous launch of the first and second automobile vehicles. A driver enable setting permits a first operator to elect to conduct the vehicle launch event. A readiness identifier is actuated in the first and second automobile vehicles and the vehicle launch event is initiated after the first operator and a second operator of the second automobile vehicle signify readiness by actuating the readiness identifier. An autonomous launch may also be conducted.

### INTRODUCTION

The present disclosure relates to coordination and instrumentation for simultaneous launch of multiple automobile vehicles in a performance driving event.

Vehicle owners of automobile vehicles may wish to compare the performance of their vehicles in a head-to-head competition setting such as in a performance driving area as a performance driving event. The current method for simultaneously launching multiple vehicles involves vehicle data acquisition in performance driving areas such as racetracks having equipment to coordinate and instrument the vehicle launch. For example, a light tree may be used to initiate a start, and timing equipment may be used to provide simple track statistics such as reaction times, ¼ mile times and the like.

Some performance driving areas do not have the equipment to coordinate a simultaneous vehicle launch such as a light tree or cannot provide past performance statistics or track statistics such as reaction times, ¼ mile times and the like for the vehicles. Performance driving systems used in performance driving areas and collecting performance statistics from previous performance driving events may also not provide past performance statistics for vehicles of a predetermined area or from areas outside of the performance driving area which can be accumulated, compared, or modified to provide historical data useful for handicapping. Performance driving areas may also not be large enough to simultaneously accommodate and accurately track in real-time multiple vehicles over driving distances of one mile or more and may also not be available to track performance data for vehicle owners in certain geographical areas.

Thus, while current performance driving systems achieve their intended purpose, there is a need for a new and improved system and method for simultaneous performance launch of multiple automobile vehicles.

### SUMMARY

According to several aspects, a multiple vehicle launch system for an automobile vehicle includes a first portion defining a vehicle-to-infrastructure (V2I) communication system to track performance data of a vehicle launch event of at least a first automobile vehicle and a second automobile vehicle and coordinate getting the first automobile vehicle and the second automobile vehicle to a driving area to conduct the vehicle launch event. A vehicle-to-vehicle (V2V) communication system provides direct communication between the first automobile vehicle and the second automobile vehicle at the driving area to coordinate a simultaneous launch of the first automobile vehicle and the second automobile vehicle. A database collecting data from the first automobile vehicle and the second automobile vehicle prior to, during and after completion of the vehicle launch event that is saved and communicated to operators of the first automobile vehicle and the second automobile vehicle.

In another aspect of the present disclosure, the driving area defines a pre-approved and predetermined performance driving area for the vehicle launch event.

In another aspect of the present disclosure, the V2V communication system functions to align the first automobile vehicle and the second automobile vehicle at the pre-approved and predetermined performance driving area and synchronizes the simultaneous launch of the first automobile vehicle and the second automobile vehicle to begin the vehicle launch event.

In another aspect of the present disclosure, a readiness identifier is provided, the simultaneous launch being initiated after an operator of the first automobile vehicle and an operator of the second automobile vehicle signify readiness by actuation of the readiness identifier.

In another aspect of the present disclosure, the readiness identifier defines an indicator presented on a view panel in the first automobile vehicle and the second automobile vehicle.

In another aspect of the present disclosure, the readiness identifier defines a sensed position change provided by displacement of at least one paddle-shifter of an automatic transmission to a neutral gear position.

In another aspect of the present disclosure, a launch countdown is simultaneously initiated in the first automobile vehicle and the second automobile vehicle after the readiness identifier is actuated.

In another aspect of the present disclosure, a driver enable setting permits a first operator of the first automobile vehicle to elect whether to be prompted to conduct the vehicle launch event and permitting the first operator to select a second operator of the second automobile vehicle.

In another aspect of the present disclosure, sensors in the first automobile vehicle and in the second automobile vehicle track automobile vehicle conditions including a vehicle speed, an engine rpm, a vehicle launch time, a current time, an elapsed time, a vehicle direction, a vehicle position, a steering wheel angle, an accelerator pedal position, a brake pedal position, and a distance traveled following the simultaneous launch of the first automobile vehicle and the second automobile vehicle.

In another aspect of the present disclosure, the database includes vehicle historical data, performance driving area information and statistics of the first automobile vehicle and the second automobile vehicle accessed by the V2I communication system prior to the vehicle launch event.

According to several aspects, a multiple vehicle launch system for an automobile vehicle includes a vehicle-to-infrastructure (V2I) communication system to track performance data of a vehicle launch event of at least a first automobile vehicle and a second automobile vehicle and coordinate getting the first automobile vehicle and the second automobile vehicle to a driving area to conduct the vehicle launch event. A vehicle-to-vehicle (V2V) communication system provides direct communication between the first automobile vehicle and the second automobile vehicle at the driving area to coordinate a simultaneous launch of the first automobile vehicle and the second automobile vehicle. A driver enable setting permits a first operator of the first automobile vehicle to elect whether to be prompted to conduct the vehicle launch event. A readiness identifier is visible on a screen of the first automobile vehicle and the second automobile vehicle. The launch event is initiated after the first operator and a second operator of the second automobile vehicle signify readiness by actuation of the readiness identifier.

In another aspect of the present disclosure, sensors in the first automobile vehicle and the second automobile vehicle generating data prior to and during the vehicle launch event for the first automobile vehicle and the second automobile vehicle.

In another aspect of the present disclosure, a database is provided where the data is saved and wherein the data is communicated from the database to operators of the first automobile vehicle and the second automobile vehicle using the V2I communication system.

In another aspect of the present disclosure, the database includes vehicle historical data, performance driving area information and statistics available to the operators prior to and during the launch event.

In another aspect of the present disclosure, a V2V communication sequence includes a back-office communication link in communication with the database to initiate a first V2V link with the first automobile vehicle and to initiate a second V2V link with the second automobile vehicle.

In another aspect of the present disclosure, in a first waiting sequence the first automobile vehicle and the second automobile vehicle participating in the launch event are allowed a time to reach a start location of the launch event; and in a second waiting sequence after completion of the first waiting sequence the first operator and the second operator signal a readiness to start the launch event.

In another aspect of the present disclosure, a countdown sequence has a countdown displayed on an infotainment screen of the first automobile vehicle and the second automobile vehicle.

According to several aspects, a method for operating a multiple vehicle launch system includes: tracking performance data of at least a first automobile vehicle and a second automobile vehicle using a vehicle-to-infrastructure (V2I) communication system for a vehicle launch event; coordinating getting the first automobile vehicle and the second automobile vehicle to a pre-approved and predetermined performance driving area pre-approved for conducting the vehicle launch event using the V2I communication system; providing direct communication between the first automobile vehicle and the second automobile vehicle using a vehicle-to-vehicle (V2V) communication system after reaching the pre-approved and predetermined performance driving area; providing data from the first automobile vehicle and the second automobile vehicle prior to and during the vehicle launch event following a simultaneous launch of the first automobile vehicle and the second automobile vehicle; and saving and communicating the data to operators of the first automobile vehicle and the second automobile vehicle.

In another aspect of the present disclosure, the method further includes displaying a countdown sequence on an infotainment screen of the first automobile vehicle and the second automobile vehicle.

In another aspect of the present disclosure, the method further includes: forwarding a first message containing a launch time, a current time, a location and a current speed of the first automobile vehicle from the first automobile vehicle to the second automobile vehicle; and forwarding a second message containing the launch time, the current time, the location and a current speed of the second automobile vehicle from the second automobile vehicle to the first automobile vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic presentation of a vehicle to infrastructure portion of a multiple vehicle launch system according to an exemplary aspect;

FIG. 2 is a diagrammatic presentation of a vehicle to vehicle portion of the multiple vehicle launch system of FIG. 1;

FIG. 3 is a diagrammatic presentation of features of a vehicle launch event of the multiple vehicle launch system of FIG. 1;

FIG. 4 is a diagrammatic presentation of the features of a launch event summary of the multiple vehicle launch system of FIG. 1;

FIG. 5 is a flow diagram of the steps for using the multiple vehicle launch system of FIG. 1; and

FIG. 6 is a communication sequence diagram for the vehicle to vehicle system portion of the multiple vehicle launch system of FIG. 1.

### DETAILED DESCRIPTION

The following description is merely exemplary in nature and is not intended to limit the present disclosure, application, or uses.

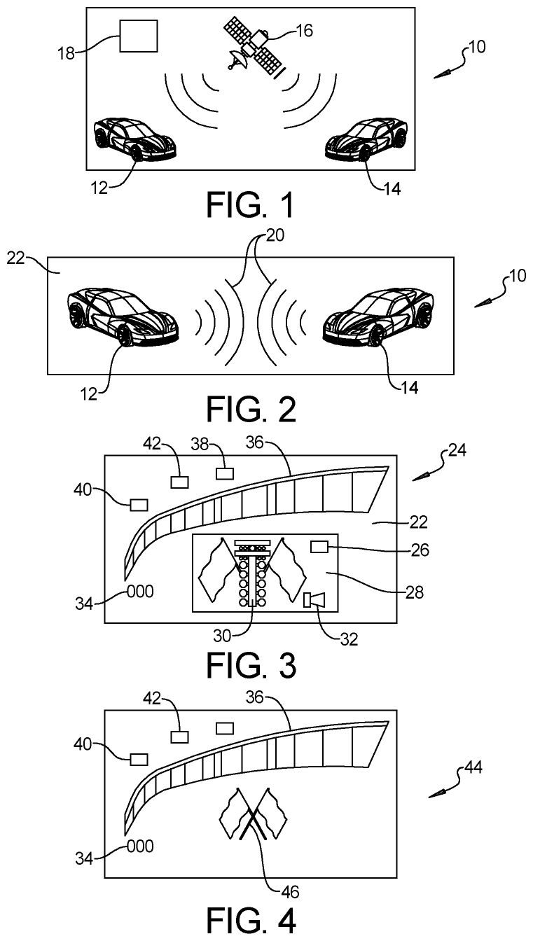

Referring to FIG. 1, a multiple vehicle launch system 10 to track performance data of a vehicle launch event of at least a first automobile vehicle 12 and a second automobile vehicle 14 provides for initial communication between the first automobile vehicle 12 and the second automobile vehicle 14 using a first portion defining a vehicle-to-infrastructure (V2I) communication system 16. “Automobile vehicles” as used herein refers generally to cars, light duty trucks including pickup trucks, vans, sport utility vehicles, engine and battery powered highway operated vehicles, motorcycles, snowmobiles, jet-skis, boats and the like. It should be appreciated that the following discussion of the first automobile vehicle 12 and the second automobile vehicle 14 is exemplary and also applies to three or more than three automobile vehicles being accommodated by the multiple vehicle launch system 10.

The V2I communication system 16 is provided in the first automobile vehicle 12 and the second automobile vehicle 14 and accesses a database 18 having vehicle historical data, performance driving area information and statistics. The database 18 is an off-site or cloud-based system which is accessible to any operator or any party who has access to the multiple vehicle launch system 10. A user defined performance simultaneous launch of the first automobile vehicle 12 and the second automobile vehicle 14 is provided that also provides data from the first automobile vehicle 12 and the second automobile vehicle 14 prior to and during the launch event that can be saved by the multiple vehicle launch system 10 and communicated to the operators of the first automobile vehicle 12 and the second automobile vehicle 14, as well as to any interested party using for example a social media platform.

The operators of the first automobile vehicle 12 and the second automobile vehicle 14 can compare performance data as a head-to-head competition. The operators can also compare their launch event data to other automobile vehicles and communicate an availability to other automobile vehicles to identify if further launch events against other automobile vehicles is desired.

Referring to FIG. 2 and again to FIG. 1, after initial communication using the V2I system 16 has been established identifying automobile vehicle data and confirming the desire of both automobile vehicles to conduct a launch event, the multiple vehicle launch system 10 provides for direct communication between the first automobile vehicle 12 and the second automobile vehicle 14 via a second portion defining a vehicle-to-vehicle (V2V) communication system 20 to coordinate getting the first automobile vehicle 12 and the second automobile vehicle 14 to a pre-approved and predetermined performance driving area 22 which has been pre-approved for conducting the launch event and therefore defines an enablement feature providing approval for the vehicles to proceed. Pre-approved and predetermined performance driving areas 22 can include but are not limited to professional race courses, land areas where land owner approval to conduct launch events has been obtained such as parking lots and abandoned airfields, and cities or towns where city or town approval to conduct launch events has been obtained.

Referring to FIG. 3 and again to FIGS. 1 and 2, after the first automobile vehicle 12 and the second automobile vehicle 14 are tracked to and aligned at the predetermined performance driving area 22 for simultaneous launch, the multiple vehicle launch system 10 then synchronizes a simultaneous launch event 24 of the first automobile vehicle and the second automobile vehicle 14. The simultaneous launch event 24 is initiated after the operator of the first automobile vehicle 12 and the operator of the second automobile vehicle 14 signify readiness by actuation of a readiness identifier 26 such as a switch or an indicator presented on a view panel 28. The readiness identifier 26 can also take the form of a sensed position change of a pedal such as actuation of a brake pedal or by simultaneous displacement of paddle-shifters of an automatic transmission to a neutral gear position. Sensors provided in the first automobile vehicle 12 and the second automobile vehicle 14 identify when the readiness identifier 26 has been actuated and collect vehicle data after the simultaneous launch event 24 is started. The sensors may include accelerometers, velocity sensors, GPS position detecting devices, timers and the like.

After the readiness identifier 26 has been actuated, a launch countdown is simultaneously initiated in both the first automobile vehicle 12 and the second automobile vehicle 14. The launch countdown can take a visual form such as a known timing light 30 shown, or a number countdown starting at a predetermined number. The launch countdown can also take the form of an audible countdown 32 or can include both visual and audible components as desired by the automobile vehicle operator.

Upon vehicle launch, sensors, global positioning system (GPS) equipment and the like in the first automobile vehicle 12 and in the second automobile vehicle 14 track automobile vehicle conditions including a vehicle speed 34 and an engine rpm 36 if available. Distance traveled over the course of the launch event, vehicle conditions, and elapsed time are provided to the operators. Upon completion of the launch event a current event total elapsed time 38, as well as a vehicle best time 40 over the driving course and a vehicle previous elapsed time 42 over the same driving course are presented to the operator and saved by the multiple vehicle launch system 10 for example in a memory of the database 18.

Referring to FIG. 4 and again to FIGS. 1 through 3, upon completion of the launch event a launch event summary 44 is generated and is made available by the multiple vehicle launch system 10 to the operators of the first automobile vehicle 12 and the second automobile vehicle 14, as well as via social media platforms to any interested parties. The launch event summary 44 identifies individual data of the automobile vehicles such as the vehicle speed 34 and the engine rpm 36 at different times of the launch event, as well as the vehicle best time 40 over the driving course and the vehicle previous elapsed time 42. A winner 46 of the launch event is also identified.

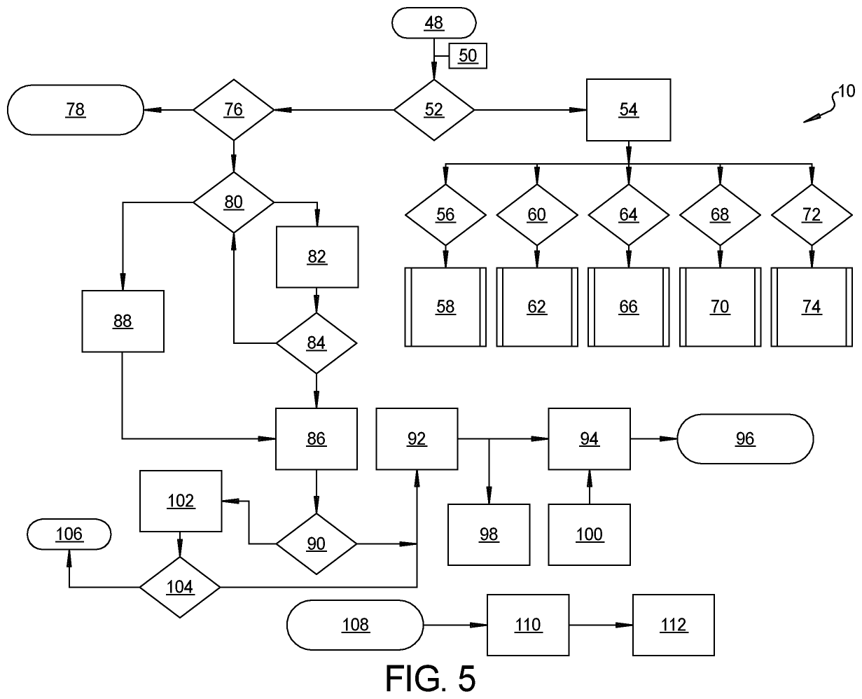

Referring to FIG. 5 and again to FIGS. 1 through 4, a methodology flow chart identifies method steps for operation of the multiple vehicle launch system 10. Initially a user 48 of an automobile vehicle enters a main menu 50 of the multiple vehicle launch system 10 and selects a “my mode” command prompt 52. The user 48 then may elect to change system settings by actuating a group launch settings 54 feature. Within the group launch settings 54 feature a driver level setting 56 can be selected which permits the user 48 to select a driver skill level 58 for competition, which can include for example a driver rating from 0 to 10, or a rating such as amateur, professional, or the like. A race length setting 60 if selected allows the user 48 to select a race length 62 such as ⅛ mile, ¼ mile, ½ mile or the like. A search radius or distance-to-race setting 64 if selected allows the user 48 to predesignate a distance range 66 from a current position or GPS location of the user 48 which the multiple vehicle launch system 10 will search for possible competitor vehicles. This feature allows the user 48 to limit a time for another operator plus the user 48 to reach a predesignated launch location or a distance between the vehicles. The distance range 66 may be for example 5 miles, 10 miles, 20 miles or 20+ miles. A handicap setting 68 if selected permits the user 48 to predetermine a vehicle limitation 70 such as a base horsepower and can be adjusted by the user 48.

A vehicle options setting 72 allows the user 48 to select from multiple vehicle limitations 74 such as manual or automatic transmission, a total quantity of vehicles in the launch event, or the user 48 may elect to perform a vehicle autonomous launch with launch conditions predefined by the user 48 when a countdown expires. The autonomous launch may include but is not limited to release of a line lock, engagement of a transmission power flow, or exiting from a temporary transmission neutral setting.

In addition to selecting the group launch settings 54, after selecting the “my mode” command prompt 52, if the user 48 selects a driver enable setting 76 the user 48 can elect whether or not to be prompted to conduct launch events, and if the user 48 wants to conduct a launch event the user 48 selects an operator or operators the user 48 wants to send prompts to. If the user 48 does not want to receive prompts to conduct launch events the user 48 selects a no-notification setting 78. If the user 48 wants to send and receive prompts to conduct launch events the user 48 selects a pairing prompt 80.

After selecting the pairing prompt 80, if the user 48 wants to send and receive prompts to a known operator such as a friend, the user 48 selects a select friend setting 82 and identifies the name of one or more friends saved in the database. The multiple vehicle launch system 10 sends a prompt to the designated friend or globally to all of the selected friends. A friend response 84 is then received. If the friend declines the prompt the system returns to the pairing prompt 80. If the friend accepts the prompt the user 48 in an identification selection 86 forwards vehicle data for the vehicle such as the first automobile vehicle 12 and the pre-approved and predetermined performance driving area 22 to the friend vehicle, and the friend vehicle such as the automobile vehicle 2 reciprocates by forwarding the vehicle data of the friend vehicle such as the automobile vehicle 2.

As an alternative to the above, after the user 48 selects the pairing prompt 80, if the user 48 wants to send and receive prompts to a random party, the user 48 selects a select random setting 88. The multiple vehicle launch system 10 sends a prompt to one or more random parties based on similar settings selected by the user 48 such as to vehicles within the predetermined distance range 66. If the random party accepts the prompt the user 48 in the identification selection 86 forwards vehicle data for the vehicle such as the first automobile vehicle 12 and the pre-approved and predetermined performance driving area 22 to the accepting vehicle operator or operators which is input into a vehicle GPS system of the accepting vehicle or vehicles such as the second automobile vehicle 14, and the random party vehicle such as the automobile vehicle 2 reciprocates by forwarding the vehicle data of the random party vehicle such as the automobile vehicle 2 to the user's vehicle such as the automobile vehicle 12.

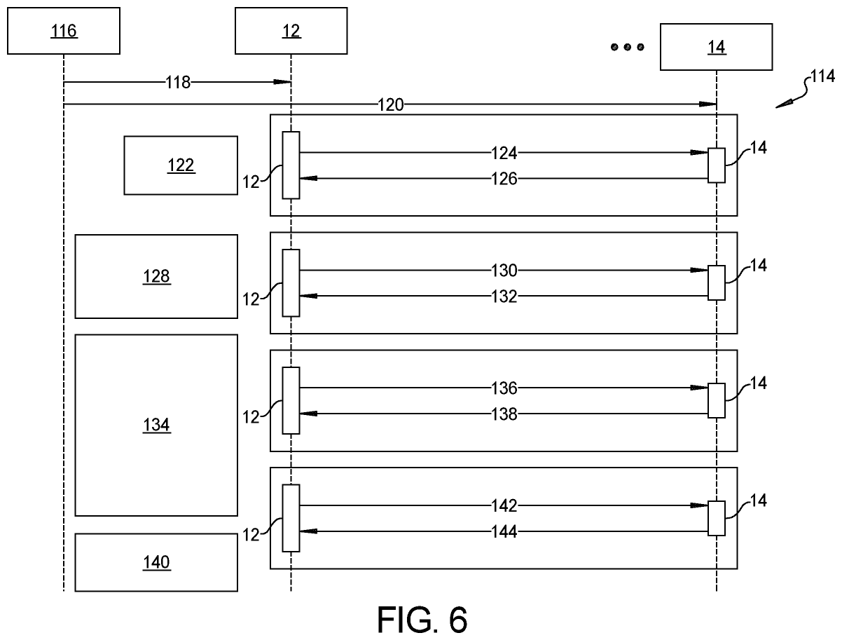

Following the identification selection 86 the user 48 and the friend or random party, now collectively identified as the contestants, in a location agreement step 90 then need to confirm their agreement to the location of the pre-approved and predetermined performance driving area 22. If the contestants agree to the location of the pre-approved and predetermined performance driving area 22 the contestants in a following step 92 use the GPS data to reach the location of the pre-approved and predetermined performance driving area 22. Once both or all the contestants reach the pre-approved and predetermined performance driving area 22, in a takeover step 94 the V2V system 20 takes over control of data for the multiple vehicle launch system 10, and a pre-launch commencement 96 begins which is discussed in greater detail in reference to FIG. 6.

If the user 48 desires to provide additional security, for example to confirm the identity of the vehicle operators to each other, during or following the following step 92 the user 48 in a passcode step 98 provides a passcode for the multiple vehicle launch system 10 to the friend or the random party such as by a smart phone message. In an input step 100 the passcode is input by the friend or the random party to enable the V2V system of the friend or random party vehicle such as the second automobile vehicle 14 to takeover in the takeover step 94.

If following the identification selection 86 the contestants do not agree to the location of the pre-approved and predetermined performance driving area 22 the user 48 in an identification step 102 identifies a new pre-approved and predetermined performance driving area and inputs GPS information for this area which is forwarded to all of the contestants. After the location agreement step 90 if all of the contestants acknowledge in an acknowledgment step 104 their agreement to use the new pre-approved and predetermined performance driving area the system enters the following step 92. If all of the contestants do not agree to use the new pre-approved and predetermined performance driving area the user 48 in a restart selection 106 returns to the “my mode” command prompt 52 to begin a search for a new and different contestant.

Following completion of the launch event 108 in a post launch step 110 the automobile vehicle of the user 48 such as the first automobile vehicle 12 sends event data such as the launch event summary 44 described in reference to FIG. 4 to a server of the database 18 described in reference to FIG. 1. Also, during the post launch step 110 the automobile vehicle of the friend or random party such as the second automobile vehicle 14 sends event data such as the launch event summary 44 described in reference to FIG. 4 to the server of the database 18. The event data such as the launch event summary 44 for the first automobile vehicle 12 and the second automobile vehicle 14, as well as any additional vehicles in a final step 112 may be reformatted and is made available to contestants and interested parties via social media such as a website or an application.

Referring to FIG. 6 and again to FIGS. 1 through 5, a V2V communication sequence 114 for the multiple vehicle launch system 10 includes a back-office communication link 116 which communicates with the database 18 described in reference to FIG. 1 and which initiates a V2V link 118 with the first automobile vehicle 12 and initiates a V2V link 120 with the second automobile vehicle 14, and with any further automobile vehicles which will participate in the launch event 108. In a first waiting sequence 122 all the automobile vehicles participating in the launch event 108 are given time to reach a start location of the launch event. The first automobile vehicle 12 forwards a first time and location confirmation 124 to the second automobile vehicle 14. Similarly, the second automobile vehicle 14 forwards a second time and location confirmation 126 to the first automobile vehicle 12.

After completion of the first waiting sequence 122 in a second waiting sequence 128 all of the operators of the vehicles participating in the launch event 108 signal a readiness to start the launch event, such as positioning transmission paddle shifters to neutral or enabling a launch control provided on a system screen such as a vehicle infotainment screen provided in the dashboard or console of known automobile vehicles. The first automobile vehicle operator signals a driver ready status 130 to the second automobile vehicle 14. Similarly, the second automobile vehicle operator signals a driver ready status 132 to the first automobile vehicle 12.

In a countdown sequence 134 a countdown is displayed, for example on the vehicles' infotainment screens. At this time, the contestant vehicles begin logging vehicle data such as vehicle kinematic data which may be forwarded in basic safety message (BSM) formatted messages. The first automobile vehicle 12 forwards a launch time, current time, location and current speed (=0) message 136 to the second automobile vehicle 14. Similarly, the second automobile vehicle 14 forwards a launch time echo, current time, location and current speed (=0) message 138 to the first automobile vehicle 12. The vehicles can alternately control autonomous launch actuation by allowing the countdown to expire as discussed above.

In a vehicle launch time window 140 vehicle data is logged during the time period of the launch event 108, while a distance travelled by the contestant vehicles is within a predefined activity area of defining the pre-approved and predetermined performance driving area 22 or the alternate area agree to by the contestants. During the launch event 108, the first automobile vehicle 12 forwards current time, location and current speed signals 142 to the second automobile vehicle 14. Similarly, the second automobile vehicle 14 forwards current time, location and current speed signals 144 to the first automobile vehicle 12.

A multiple vehicle launch system 10 of the present disclosure offers several advantages. These include utilization of V2I and V2V communication as well as a vehicle infotainment system to coordinate the start of a simultaneous vehicle launch event. Automobile vehicle performance data collected prior to and during the event from existing automobile vehicle sensors is computed and stored using V2V communication. This data is used to compute performance driving area statistics and is also made available to the user.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A multiple vehicle launch system for an automobile vehicle, comprising:
a vehicle-to-vehicle (V2V) communication system providing direct communication between a first automobile vehicle and a second automobile vehicle located at a driving area to track performance data of a vehicle launch event and to coordinate a simultaneous launch of the first automobile vehicle and the second automobile vehicle; and
a database collecting data from the first automobile vehicle and the second automobile vehicle prior to, during and after completion of the vehicle launch event that is saved and communicated to operators of the first automobile vehicle and the second automobile vehicle.

2. The system of claim 1, further including a vehicle-to-infrastructure (V2I) communication system to track the performance data of the vehicle launch event and to coordinate getting the first automobile vehicle and the second automobile vehicle to the driving area;
wherein the driving area defines a pre-approved and predetermined performance driving area for the vehicle launch event thereby providing approval to the first automobile vehicle and to the second automobile vehicle to proceed with the vehicle launch event.

3. The system of claim 2, wherein the V2V communication system functions to align the first automobile vehicle and the second automobile vehicle at the pre-approved and predetermined performance driving area and synchronizes the simultaneous launch of the first automobile vehicle and the second automobile vehicle to begin the vehicle launch event.

4. The system of claim 3, further including a readiness identifier wherein the simultaneous launch is initiated after an operator of the first automobile vehicle and an operator of the second automobile vehicle signify readiness by actuation of the readiness identifier.

5. The system of claim 4, wherein the readiness identifier defines an indicator presented on a view panel in the first automobile vehicle and the second automobile vehicle.

6. The system of claim 4, wherein the readiness identifier defines a sensed position change provided by displacement of at least one paddle-shifter of an automatic transmission to a neutral gear position.

7. The system of claim 4, further including a launch countdown simultaneously initiated in the first automobile vehicle and the second automobile vehicle after the readiness identifier is actuated.

8. The system of claim 2, further including a driver enable setting permitting a first operator of the first automobile vehicle to elect whether to be prompted to conduct the vehicle launch event and permitting the first operator to select a second operator of the second automobile vehicle; and
wherein the database includes vehicle historical data, performance driving area information and statistics of the first automobile vehicle and the second automobile vehicle accessed by the V2I communication system prior to the vehicle launch event.

9. The system of claim 1, further including sensors in the first automobile vehicle and in the second automobile vehicle tracking automobile vehicle conditions following the vehicle launch event of the first automobile vehicle and the second automobile vehicle.

10. The system of claim 1, further including a vehicle autonomous launch of one of the first automobile vehicle or the second automobile vehicle with launch conditions predefined by an operator of the one of the first automobile vehicle or the second automobile vehicle when a countdown expires.

11. A multiple vehicle launch system for an automobile vehicle, comprising:
a vehicle-to-infrastructure (V2I) communication system to track performance data of a vehicle launch event of at least a first automobile vehicle and a second automobile vehicle and coordinate getting the first automobile vehicle and the second automobile vehicle to a preapproved driving area to conduct the vehicle launch event;
a vehicle-to-vehicle (V2V) communication system providing direct communication between the first automobile vehicle and the second automobile vehicle at the preapproved driving area to coordinate a simultaneous launch of the first automobile vehicle and the second automobile vehicle;
a driver enable setting permitting a first operator of the first automobile vehicle to elect whether to be prompted to conduct the vehicle launch event; and
a readiness identifier actuated in the first automobile vehicle and the second automobile vehicle wherein the vehicle launch event is initiated after the first operator and a second operator of the second automobile vehicle signify readiness by actuation of the readiness identifier.

12. The system of claim 11, further including sensors in the first automobile vehicle and the second automobile vehicle generating data prior to and during the vehicle launch event for the first automobile vehicle and the second automobile vehicle.

13. The system of claim 12, further including a database where the data is saved and wherein the data is communicated from the database to operators of the first automobile vehicle and the second automobile vehicle using the V2I communication system.

14. The system of claim 13, wherein the database includes vehicle historical data, performance driving area information and statistics available to the first operator and to the second operator prior to and during the vehicle launch event.

15. The system of claim 13, further including a V2V communication sequence including a back-office communication link in communication with the database to initiate a first V2V link with the first automobile vehicle and to initiate a second V2V link with the second automobile vehicle.

16. The system of claim 15, wherein:
in a first waiting sequence the first automobile vehicle and the second automobile vehicle participating in the vehicle launch event are allowed a time to reach a start location of the vehicle launch event; and
in a second waiting sequence after completion of the first waiting sequence the first operator and the second operator signal a readiness to start the vehicle launch event.

17. The system of claim 16, further including a countdown sequence having a countdown disclosed in the first automobile vehicle and the second automobile vehicle.

18. A method for operating a multiple vehicle launch system, comprising:
tracking performance data of at least a first automobile vehicle and a second automobile vehicle using a vehicle-to-infrastructure (V2I) communication system for a vehicle launch event;
coordinating getting the first automobile vehicle and the second automobile vehicle to a pre-approved and predetermined performance driving area pre-approved for conducting the vehicle launch event using the V2I communication system;
providing direct communication between the first automobile vehicle and the second automobile vehicle using a vehicle-to-vehicle (V2V) communication system after reaching the pre-approved and predetermined performance driving area;
providing data from the first automobile vehicle and the second automobile vehicle prior to and during the vehicle launch event following a simultaneous launch of the first automobile vehicle and the second automobile vehicle; and
saving and communicating the data to operators of the first automobile vehicle and the second automobile vehicle.

19. The method for operating a multiple vehicle launch system of claim 18, further including providing a countdown sequence in the first automobile vehicle and the second automobile vehicle.

20. The method for operating a multiple vehicle launch system of claim 19, further including:
forwarding a first message containing a launch time, a current time, a location and a current speed of the first automobile vehicle from the first automobile vehicle to the second automobile vehicle; and
forwarding a second message containing the launch time, the current time, the location and a current speed of the second automobile vehicle from the second automobile vehicle to the first automobile vehicle.
